(19) United States
(12) Patent Application Publication
(10) Pub. No.: US 2024/0064797 A1
(43) Pub. Date: Feb. 22, 2024

(54) Prioritized Data Transmission

(71) Applicant: Apple Inc., Cupertino, CA (US)

(72) Inventors: Fangli XU, Beijing (CN); Dawei ZHANG, Saratoga, CA (US); Haijing HU, Los Gatos, CA (US); Sarma VANGALA, Campbell, CA (US); Murtaza A SHIKARI, Mountain View, CA (US); Srinivasan NIMMALA, San Jose, CA (US); Ralf ROSSBACH, Munich (DE)

(21) Appl. No.: 18/259,517

(22) PCT Filed: May 31, 2021
(86) PCT No.: PCT/CN2021/097434

§ 371 Date: Jun. 27, 2023

(30) Foreign Application Priority Data
Jan. 15, 2021 (WO) PCT/CN2021/072078

(51) Int. Cl. H04W 72/566; H04L 1/1825; H04L 1/1829; H04L 1/1867

(52) U.S. Cl. CPC H04W 72/569; H04L 1/1825; H04L 1/1864; H04L 1/188; H04L 1/1887; H04L 1/1896

(57) ABSTRACT

Embodiments of the present disclosure relate to devices, methods, apparatuses and computer readable storage media for prioritizing data transmissions. According to embodiments of the present disclosure, in accordance with a determination that a first condition to enter a prioritized transmission phase is satisfied, a device prioritizes, based on a first priority rule, data transmissions from a terminal device to a network device and associated with a service. In accordance with a determination that a second condition to leave the prioritized transmission phase is satisfied, the device ceases prioritizing the data transmissions associated with the service.

### TECHNICAL FIELD

Embodiments of the present disclosure generally relate to the field of telecommunications, and in particular, to a method, device, apparatus and computer program product for prioritizing data transmissions.

### BACKGROUND

Release 17 (Rel-17) of third Generation Partnership Project (3GPP) specifications include Radio Access Network (RAN) enhancements. The RAN enhancements may depend on new Quality of Service (QoS) related parameters, such as survival time, burst spread, etc. However, the traditional RAN is of poor performance for lacking consideration of the new QoS related parameters.

### SUMMARY

In general, example embodiments of the present disclosure provide a method, device, apparatus and computer program product for prioritizing data transmissions.

In a first aspect, there is provided a method. The method comprises in accordance with a determination that a first condition to enter a prioritized transmission phase is satisfied, prioritizing, based on a first priority rule, data transmissions from a terminal device to a network device and associated with a service; and in accordance with a determination that a second condition to leave the prioritized transmission phase is satisfied, ceasing prioritizing the data transmissions associated with the service.

In a second aspect, there is provided a terminal device. The terminal device comprises at least one processor and at least one memory including computer program codes. The at least one memory and the computer program codes are configured to, with the at least one processor, cause the terminal device to, in accordance with a determination that a first condition to enter a prioritized transmission phase is satisfied, prioritize, based on a first priority rule, data transmissions to a network device and associated with a service; and in accordance with a determination that a second condition to leave the prioritized transmission phase is satisfied, cease prioritizing the data transmissions associated with the service.

In a third aspect, there is provided a baseband processor of a terminal device configured to perform the method according to the above first aspect of the present disclosure.

In a fourth aspect, there is provided a computer readable storage medium comprising program instructions stored thereon. The instructions, when executed by an apparatus, cause the apparatus to perform the method according to the above first aspect.

In a fifth aspect, there is provided a computer program product that is stored on a computer readable medium and includes machine-executable instructions. The machine-executable instructions, when being executed, cause a machine to perform the method according to the above first aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 shows an example communication network in which example embodiments of the present disclosure can be implemented;

FIG. 2 illustrates a flowchart of an example method for prioritized data transmissions according to some example embodiments of the present disclosure;

FIG. 3 illustrates a schematic diagram of first interactions between devices according to some example embodiments of the present disclosure;

FIG. 4 illustrates a schematic diagram of second interactions between devices including a prioritized transmission phase according to some example embodiments of the present disclosure;

FIG. 5 illustrates a schematic diagram of third interactions between devices including a prioritized transmission phase according to some example embodiments of the present disclosure;

FIG. 6 illustrates a schematic diagram of fourth interactions between devices including a prioritized transmission phase according to some example embodiments of the present disclosure;

FIG. 7 illustrates a schematic diagram of fifth interactions between devices including a prioritized transmission phase according to some example embodiments of the present disclosure;

FIG. 8 illustrates a schematic diagram of sixth interactions between devices including a prioritized transmission phase according to some example embodiments of the present disclosure;

FIG. 9 illustrates a schematic diagram of seventh interactions between devices including a prioritized transmission phase according to some example embodiments of the present disclosure;

FIG. 10 illustrates a schematic diagram of eighth interactions between devices including a prioritized transmission phase according to some example embodiments of the present disclosure;

FIG. 11 illustrates a schematic diagram of ninth interactions between devices including a prioritized transmission phase according to some example embodiments of the present disclosure;

FIG. 12 illustrates a schematic diagram of tenth interactions between devices including a prioritized transmission phase according to some example embodiments of the present disclosure;

FIG. 13 illustrates a schematic diagram of eleventh interactions between devices including a prioritized transmission phase according to some example embodiments of the present disclosure;

FIG. 14 illustrates a schematic diagram of twelfth interactions between devices including a prioritized transmission phase according to some example embodiments of the present disclosure;

FIG. 15 illustrates a schematic diagram of thirteenth interactions between devices including a prioritized transmission phase according to some example embodiments of the present disclosure;

FIG. 16 illustrates a simplified block diagram of a device that is suitable for implementing example embodiments of the present disclosure and

FIG. 17 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT), New Radio (NR) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay node, a low power node such as a femto, a pico, and so forth, depending on the applied terminology and technology. An example of the relay node may be an Integrated Access and Backhaul (IAB) node. A distributed unit (DU) part of the IAB node may perform the functionalities of “network device” and thus can operate as the network device. In the following description, the terms “network device”, “BS”, and “node” may be used interchangeably.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a relay node, a device operating on commercial and/or industrial wireless networks, and the like. A Mobile Termination (MT) part of the IAB node may perform the functionalities of “terminal device” and thus can operate as the terminal device. In the following description, the terms “terminal device”, “communication device”, “terminal”, “user equipment” and “UE” may be used interchangeably.

Although functionalities described herein can be performed, in various example embodiments, in a fixed and/or a wireless network node may, in other example embodiments, functionalities may be implemented in a user equipment apparatus (such as a cell phone or tablet computer or laptop computer or desktop computer or mobile JOT device or fixed JOT device). This user equipment apparatus can, for example, be furnished with corresponding capabilities as described in connection with the fixed and/or the wireless network node(s), as appropriate. The user equipment apparatus may be the user equipment and/or or a control device, such as a chipset or processor, configured to control the user equipment when installed therein. Examples of such functionalities include the bootstrapping server function and/or the home subscriber server, which may be implemented in the user equipment apparatus by providing the user equipment apparatus with software configured to cause the user equipment apparatus to perform from the point of view of these functions/nodes.

As briefly discussed above, the RAN enhancements may depend on the new QoS related parameters, such as survival time, burst spread, etc. The System Architecture 2 (SA2) agreement and definition provides some definitions for the survival time. For example, in Technical Specification (TS) 22.104, the survival time is defined as the time that an application consuming a communication service may continue without an anticipated message, i.e. the application's tolerance to loss. As another example, according to TS 23.700-020, the survival time can be conveyed to the RAN as a parameter of Timing Sensitive Communication Assistive Information (TSCAI) (along with burst periodicity), and the survival time can be specified in units of time or as the maximum number of consecutive message transmission failures. In addition, in RAN2 #112e agreement, a time period during which message loss can be tolerated is adopted as the preferred format for the survival time.

In a more specific example, a receiver will wait a pre-set period (i.e. survival time) before it considers the communication service to be unavailable. Upon the survival time expiry, the receiver will transit into a down state. The target application of the receiver will usually take corresponding actions for handling such situations of unavailable communication services. Note that this does not imply that the target application is shut off. Instead, the target application transitions into a pre-defined state, e.g. a safe state. In the safe state, the receiver might still listen to incoming packets or may try to send messages to the source application. It can be seen that the survival time is a key characteristic that determines the communication service availability of the cyber-physical application, in order to fulfill its service performance requirement.

The survival time has several impacts on the RAN scheduling. For example, in case of transmission failure, the subsequent transmission may ensure the transmission to be successful before the survival time expires. In addition, in case of first transmission failure, the retransmission may ensure the transmission to be successful before the survival time expires. Further, if no data transmission success occurs during the survival time, the data transmission during the recovery phase may recover the uplink communication into a normal state. In this case, how to prioritize the data transmissions becomes can an issue to be solved.

Embodiments of the present disclosure propose a solution for prioritizing data transmissions, so as to solve the above problems and one or more of other potential problems. In this solution, if a first condition to enter a prioritized transmission phase is satisfied, data transmissions from a terminal device to a network device and associated with a service are prioritized based on a first priority rule. In addition, if a second condition to leave the prioritized transmission phase is satisfied, the prioritizing of the data transmissions associated with the service is ceased.

In this way, the data transmissions may be prioritized to ensure the transmission to be successful. Thereby, the reliability and performance of RAN can be enhanced.

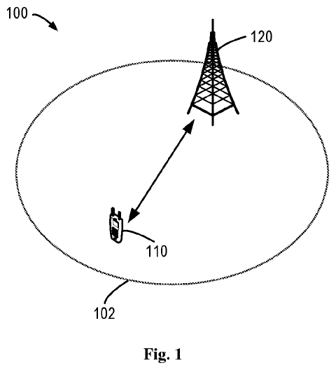

Principle and implementations of the present disclosure will be described in detail below with reference to FIGS. 1-17.

FIG. 1 shows an example communication network 100 in which example embodiments of the present disclosure can be implemented. The communication network 100 includes a terminal device 110 and a network device 120 serving the terminal device 110. The terminal device 110 and the network device 120 can communicate with each other. The serving area of the network device 120 is called as a cell 102. It is to be understood that the number of terminal devices, network devices and cells is only for the purpose of illustration without suggesting any limitations. The communication network 100 may include any suitable number of terminal devices, network devices and cells adapted for implementing embodiments of the present disclosure. Furthermore, the functionalities of the network device can be split into multiple network nodes, such as Transmission and Reception Points (TRPs), centralized unit (CU) and DU, etc. Although not shown, it would be appreciated that a plurality of terminal devices may be located in the cell 102 and served by the network device 120.

Communications in the communication network 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Divided Multiple Address (CDMA), Frequency Divided Multiple Address (FDMA), Time Divided Multiple Address (TDMA), Frequency Divided Duplexer (FDD), Time Divided Duplexer (TDD), Multiple-Input Multiple-Output (MIMO), Orthogonal Frequency Divided Multiple Access (OFDMA) and/or any other technologies currently known or to be developed in the future.

In the network 100, the terminal device 110 and the network device 120 can communicate data and control information to each other. A link from the network device 120 to the terminal device 110 is referred to as a downlink (DL), while a link from the terminal device 110 to the network device 120 is referred to as an uplink (UL).

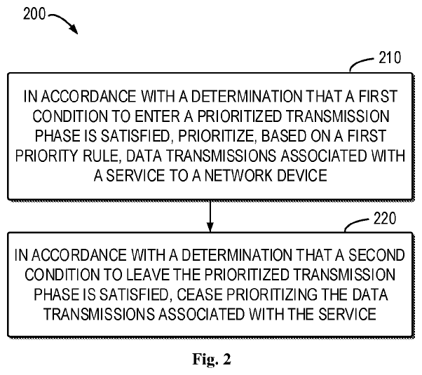

FIG. 2 shows a flowchart of an example method 200 for prioritized transmissions in accordance with some example embodiments of the present disclosure. The method 200 can be implemented at the terminal device 110 shown in FIG. 1. It is to be understood that the method 200 may include additional blocks not shown and/or may omit some shown blocks, and the scope of the present disclosure is not limited in this regard.

At block 210, in accordance with a determination that a first condition to enter a prioritized transmission phase is satisfied, the terminal device 110 prioritizes, based on a first priority rule, data transmissions associated with a service from a terminal device to a network device. In some embodiments, the service is specific to a logical channel, a data radio bearer (DRB) and/or a QoS flow. In some embodiments, the prioritized transmission phase is the transmission phase for the survival time period.

The first condition to enter the prioritized transmission phase may be satisfied under several conditions. In some embodiments, the failures of a predetermined number of data transmissions associated with the service can be used for triggering the first condition. In this case, if the predetermined number of data transmissions associated with the service fail, the terminal device 110 may determine that the first condition is satisfied. In this disclosure, the predetermined number may be any appropriate number. For example, the predetermined number of data transmissions may be a single data transmission, or multiple data transmissions, such as 4 times of data transmissions.

In some embodiments, the time since a failure of a data transmission associated with the service can be used for triggering the first condition. For example, if a data transmission associated with the service fails, the terminal device 110 may start a first timer. On one hand, if a data transmission associated with the service is successful, the terminal device 110 may stop the first timer. On the other hand, if the first timer expires, the terminal device 110 may determine that the first condition is satisfied.

Further, in some embodiments, the network device 120 can trigger the first condition. For example, if the terminal device 110 receives an indication for entering the prioritized transmission phase from the network device 120, the terminal device 110 may determine that the first condition is satisfied.

In some embodiments, prioritizing data transmissions associated with the service may comprise prioritizing a data retransmission associated with the service, or prioritizing a new data transmission associated with the service. For example, the data retransmission may comprise Hybrid Automatic Repeat reQuest (HARQ) retransmission, Radio Link Control (RLC) retransmission, and/or Packet Data Convergence Protocol Protocol Data Unit (PDCP PDU) retransmission.

In addition, in some embodiments, the prioritized transmission may be performed for data packets marked with prioritized flags. For example, the terminal device 110 may mark a data packet associated with the service with a prioritized flag, and prioritize a transmission of the data packet marked with the prioritized flag. By using the prioritized flags, data packets in a prioritized transmission phase can be easily differentiated from other data packets in a normal transmission phase.

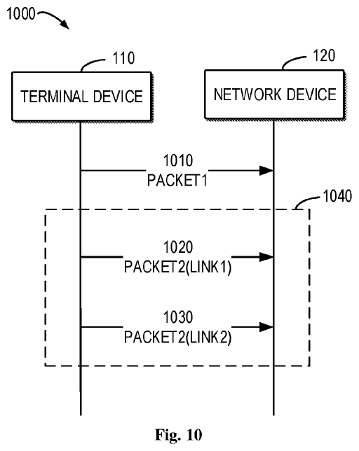

The ruled-based prioritized transmission of the data packet will be described in more detail below with reference to FIGS. 10-15.

At block 220, in accordance with a determination that a second condition to leave the prioritized transmission phase is satisfied, the terminal device 110 ceases prioritizing the data transmissions associated with the service.

The second condition to leave the prioritized transmission phase may be satisfied under several conditions. In some embodiments, the successes of a predetermined number of consecutive data transmissions associated with the service can be used for triggering the second condition. For example, if the predetermined number of consecutive data transmissions associated with the service is successful, the terminal device 110 may determine that the second condition is satisfied. Although the data transmissions are described as consecutive, the success of a single data transmission associated with the service may also lead the second condition to be satisfied.

Alternatively, in addition to the number of data transmissions, the time period in which the data transmissions occur can also be used for triggering the second condition. For example, if a predetermined number of data transmissions associated with the service within a predetermined time period is successful, the terminal device 110 may determine that the second condition is satisfied.

In some embodiments, the time since a failure of a data transmission associated with the service or since the first condition is satisfied can be used for triggering the second condition. For example, if a data transmission associated with the service fails or the first condition is satisfied, the terminal device 110 may start a second timer. On one hand, if a data transmission associated with the service successes, the terminal device 110 may stop the second timer. On the other hand, if the second timer expires, the terminal device 110 may determine that the second condition is satisfied.

Further, in some embodiments, the network device 120 can trigger the second condition. For example, if the terminal device 110 receives an indication for leaving the prioritized transmission phase from the network device 120, the terminal device 110 may determine that the second condition is satisfied.

Various conditions for entering/leaving the prioritized transmission phase have been considered, such that the data transmissions can be prioritized as needed. In this case, the data transmission may be prioritized to ensure the transmission to be successful, and thus the reliability and performance of RAN can be enhanced.

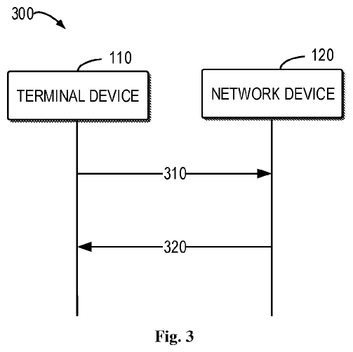

In some embodiments, before prioritizing the data transmissions, the terminal device 110 can report its capability to support the prioritized transmission phase, and the network device 120 can configure the prioritized transmission phase. For example, FIG. 3 illustrates a schematic diagram of first interactions 300 between devices according to some example embodiments of the present disclosure. As shown in FIG. 3, the terminal device 110 transmits 310 capability information of the terminal device 110 to the network device 120. The capability information indicates that the terminal device 110 supports the prioritized transmission phase.

The network device 120 can enable the prioritized transmission phase via Radio Resource Control (RRC) reconfiguration procedure, and configure the priority rule and condition to enter and leave the prioritized transmission phase. The configuration can be per Logical Channel (LCH), per DRB, per QoS flow, or per UpLink (UL) grant.

As discussed above, the transmission phase for the survival period of the terminal device 110 can be prioritized. In addition, in some embodiments, the transmission phase for the recovery period of the terminal device 110 can also be prioritized. In this case, the network device 120 can configure different prioritized phases, and configure different priority rules for these prioritized phases. For example, the network device 120 can configure a first priority rule for a prioritized transmission phase for survival period of the terminal device 110, and/or configure a different second priority rule for a further prioritized transmission phase for recovery period of the terminal device 110. Further, the network device 120 can also configure a priority rule for a normal transmission phase.

In this case, the network device 120 may transmit 320 a configuration about the service from the network device 120. The configuration indicates the first condition, the second condition, and/or the first priority rule. Then, the terminal device 110 may receive the configuration about the service from the network device 120.

In this way, the terminal device 110 and the network device 120 can cooperate in the prioritizing of data transmissions, and thus the reliability and performance of RAN can be enhanced.

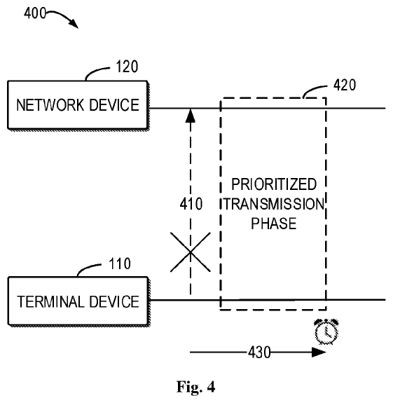

Moreover, in the above text, several first conditions to enter the prioritized transmission phase and second conditions to leave the prioritized transmission phase are described. These first and second conditions can be combined as needed. Some example combinations of the first and second conditions will be described in more detail below with reference to FIGS. 4-8.

FIG. 4 illustrates a schematic diagram of second interactions 400 between devices including a prioritized transmission phase according to some example embodiments of the present disclosure. As shown in FIG. 4, a single data transmission 410 associated with the service fails. In this case, the terminal device 110 determines that the first condition is satisfied, and enters a prioritized transmission phase 420. In addition, the terminal device 110 starts 430 a second timer to leave the prioritized transmission phase 420. If the second timer expires, the terminal device 110 determines that the second condition is satisfied, and leaves the prioritized transmission phase 420.

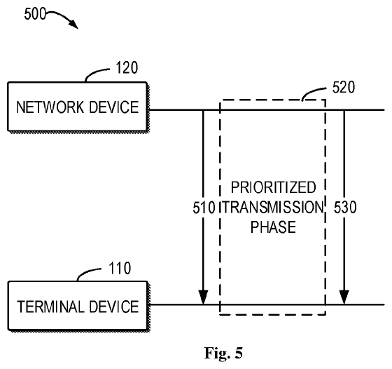

FIG. 5 illustrates a schematic diagram of third interactions 500 between devices including a prioritized transmission phase according to some example embodiments of the present disclosure. As shown in FIG. 5, the terminal device 110 receives 510 an indication for entering a prioritized transmission phase from the network device 120. In this case, the terminal device 110 determines that the first condition is satisfied, and enters a prioritized transmission phase 520. Later, the terminal device 110 receives 530 an indication for leaving the prioritized transmission phase 520 from the network device 120. In this case, the terminal device 110 determines that the second condition is satisfied, and leaves the prioritized transmission phase 520.

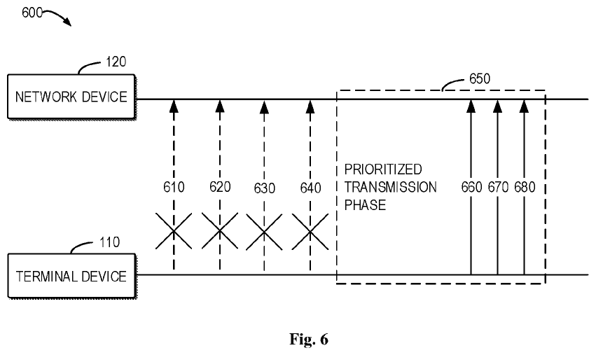

FIG. 6 illustrates a schematic diagram of fourth interactions 600 between devices including a prioritized transmission phase according to some example embodiments of the present disclosure. As shown in FIG. 6, a predetermined number of data transmission associated with the service fail. In the example of FIG. 6, the data transmissions 610-640 fail. In this case, the terminal device 110 determines that the first condition is satisfied, and enters a prioritized transmission phase 650. After successes of a predetermined number of consecutive data transmissions associated with the service, for example, the data transmissions 660-680, the terminal device 110 determines that the second condition is satisfied, and leaves the prioritized transmission phase 650.

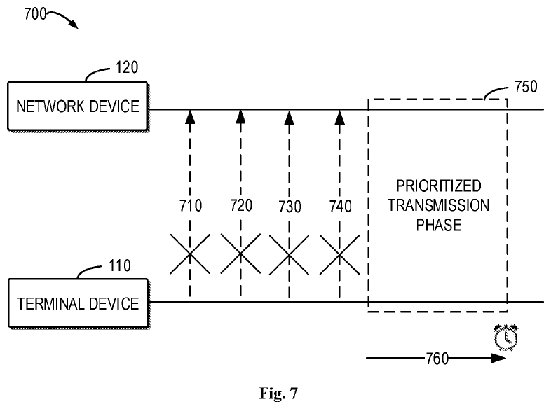

FIG. 7 illustrates a schematic diagram of fifth interactions 700 between devices including a prioritized transmission phase according to some example embodiments of the present disclosure. As shown in FIG. 7, a predetermined number of data transmission associated with the service fail. In the example of FIG. 7, the data transmissions 710-740 fail. In this case, the terminal device 110 determines that the first condition is satisfied, and enters a prioritized transmission phase 750. In addition, the terminal device 110 starts 760 a second timer to leave the prioritized transmission phase 750. If the second timer expires, the terminal device 110 determines that the second condition is satisfied, and leaves the prioritized transmission phase 750.

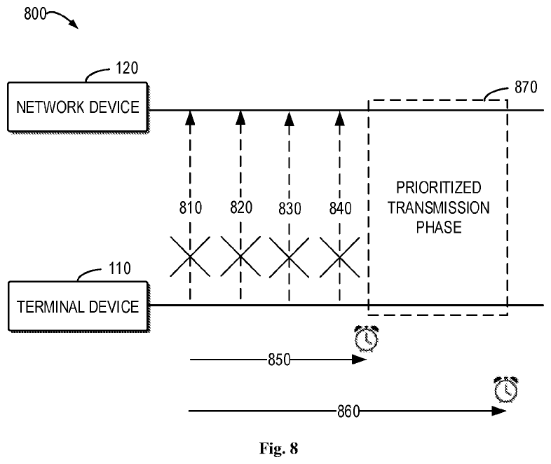

FIG. 8 illustrates a schematic diagram of sixth interactions 800 between devices including a prioritized transmission phase according to some example embodiments of the present disclosure. As shown in FIG. 8, a first data transmission 810 associated with the service fails. The terminal device 110 starts 850 a first timer for entering a prioritized transmission phase, and starts 860 a second timer for leaving the prioritized transmission phase. The following data transmissions 820-840 also fail and the first timer expires. In this case, the terminal device 110 determines that the first condition is satisfied, and enters a prioritized transmission phase 870. If the second timer expires, the terminal device 110 determines that the second condition is satisfied, and leaves the prioritized transmission phase 870.

Furthermore, as discussed above, in addition to the transmission phase for the survival period of the terminal device 110, a further transmission phase for the recovery period of the terminal device 110 can also be prioritized. In the case that the network device 120 configures the further prioritized transmission phase for the recovery period, the terminal device 110 can enter the further prioritized transmission phase for the recovery period when leaving the transmission phase for the survival period.

In some embodiments, if a third condition to enter a further prioritized transmission phase is satisfied, the terminal device 110 can prioritize, based on a second priority rule, data transmissions from the terminal device 110 to the network device 120 and associated with the service. In addition, if a fourth condition to leave the further prioritized transmission phase is satisfied, the terminal device 110 can cease prioritizing data transmissions associated with the service.

In some embodiments, timers can be used for triggering the third and fourth conditions. For example, for the third condition, if a data transmission associated with the service fails or the first condition is satisfied, the terminal device 110 can start a second timer. On one hand, if a data transmission associated with the service successes, the terminal device 110 can stop the second timer. On the other hand, if the second timer expires, the terminal device 110 can determine that the third condition is satisfied.

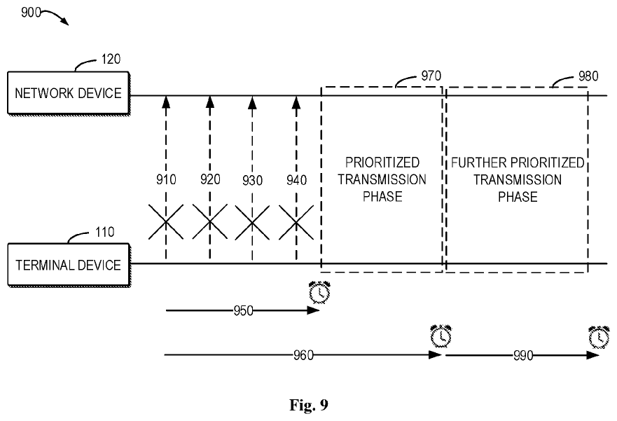

In addition, for the fourth condition, if the third condition is satisfied, the terminal device 110 can start a third timer. In this case, if a predetermined number of data transmissions associated with the service success, the terminal device 110 can stop the third timer. Alternatively, if the third timer expires, the terminal device 110 can determine that the fourth condition is satisfied. An example of prioritizing the further transmission phase for the recovery period of the terminal device 110 is described with reference to FIG. 9.

FIG. 9 illustrates a schematic diagram of seventh interactions 900 between devices including a prioritized transmission phase and a further prioritized transmission phase according to some example embodiments of the present disclosure. As shown in FIG. 9, a first data transmission 910 associated with the service fails. The terminal device 110 starts 950 a first timer for entering a prioritized transmission phase, and starts 960 a second timer for leaving the prioritized transmission phase. The following data transmissions 920-940 also fail and the first timer expires. In this case, the terminal device 110 determines that the first condition is satisfied, and enters a prioritized transmission phase 970. If the second timer expires, the terminal device 110 determines that the second condition is satisfied, and leaves the prioritized transmission phase 970.

Since the prioritized transmission phase for the recovery period is also configured, the terminal device 110 determines that the third condition is satisfied as the second timer expires. In this case, the terminal device 110 enters the further prioritized transmission phase 980, and starts 990 a third timer. If a predetermined number of data transmissions associated with the service success, the terminal device 110 stops the third timer. Alternatively, if the third timer expires, the terminal device 110 determines that the fourth condition is satisfied, and leaves the further prioritized transmission phase 980.

The entering/leaving conditions for different prioritized transmission phases are described above, in the following text, the rule-based prioritized transmission of the data packet will be described in more detail below with reference to FIGS. 10-15.

As one example of the priority rule, in the prioritized transmission phase, the data packet can be duplicated to ensure the data transmission to be successful. FIG. 10 illustrates a schematic diagram of eighth interactions 1000 between devices including prioritized transmissions according to some example embodiments of the present disclosure. As shown in FIG. 10, for the packet 1, the transmission of this packet is not prioritized. In this case, the terminal device 110 only transmits 1010 this packet to the network device 120 once. In contrast, the transmission of the packet 2 is prioritized. Thereby, in the prioritized transmission phase 1040, the terminal device 110 activates duplication, for example PDCP duplication, for the transmission of this packet. That is to say, the terminal device 110 transmits 1020 the packet 2 to the network device 120 in one link, such as link 1, and transmits 1030 a duplicated packet 2 to the network device 120 in another link, such as link 2.

As another example of the priority rule, in the prioritized transmission phase, the link with good radio quality can be selected to ensure the data transmission to be successful. For example, the link with good radio quality may indicate a link with radio quality exceeding a predetermined radio quality, or a link with radio quality superior to radio qualities of other links. In some embodiments, the terminal device 110 may select, from a plurality of links between the terminal device 110 and the network device 120, a link with radio quality exceeding a predetermined threshold, and perform the transmission of the data packet with the selected link.

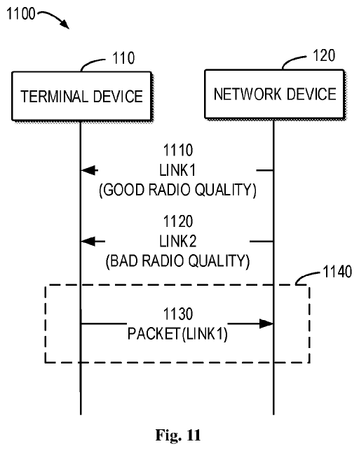

FIG. 11 illustrates a schematic diagram of ninth interactions 1100 between devices including prioritized transmissions according to some example embodiments of the present disclosure. As shown in FIG. 11, the network device 120 notifies the terminal device 110 of the link information. The link information includes the radio quality of the link Specifically, the network device 120 notifies 1110 the terminal device 110 of the information about the link 1, and notifies 1120 the terminal device 110 of the information about the link 2. The terminal device 110 may select the link 1 with good radio quality and perform 1130 the transmission of the data packet with the link 1 in the prioritized transmission phase 1140.

As another example of the priority rule, in the prioritized transmission phase, the uplink grant with good reliability can be selected to ensure the data transmission to be successful. For example, the uplink grant with good reliability may indicate an uplink grant with reliability exceeding a predetermined reliability, or an uplink grant with reliability superior to reliability of other uplink grants. In some embodiments, the terminal device 110 may select, from a plurality of uplink grants configured by the network device 120, an uplink grant with reliability exceeding a predetermined threshold, and perform the transmission of the data packet based on the selected uplink grant.

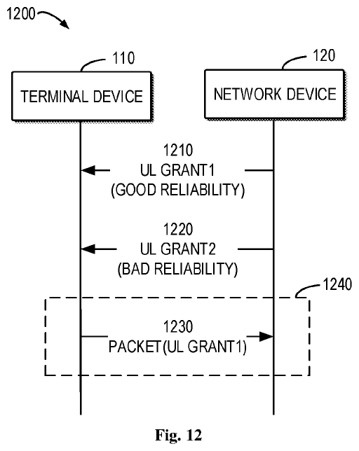

FIG. 12 illustrates a schematic diagram of tenth interactions 1200 between devices including prioritized transmissions according to some example embodiments of the present disclosure. As shown in FIG. 12, the network device 120 notifies the terminal device 110 of the uplink grant information. The uplink grant information includes the reliability of the uplink grant. Specifically, the network device 120 notifies 1210 the terminal device 110 of the information about the uplink grant 1, and notifies 1220 the terminal device 110 of the information about the uplink grant 2. The terminal device 110 may select the uplink grant 1 with good reliability and perform 1230 the transmission of the data packet with the uplink grant 1 in the prioritized transmission phase 1240.

As another example of the priority rule, the network device 120 may configure an uplink grant for the prioritized transmission phase. In this case, in the prioritized transmission phase, such uplink grant can be selected to ensure the data transmission to be successful. In some embodiments, the terminal device 110 may select, from a plurality of uplink grants configured by the network device, an uplink grant configured for the prioritized transmission phase, and perform the transmission of the data packet based on the selected uplink grant.

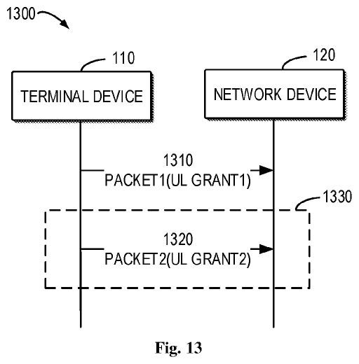

FIG. 13 illustrates a schematic diagram of eleventh interactions 1300 between devices including prioritized transmissions according to some example embodiments of the present disclosure. As shown in FIG. 13, for the packet 1, the transmission of this packet is not prioritized. In this case, the terminal device 110 performs the transmission of this packet based on the legacy uplink grant 1. The legacy uplink grant 1 is an uplink grant which is not configured for the prioritized transmission phase.

In contrast, the transmission of the packet 2 is prioritized. Thereby, the terminal device 110 may select the uplink grant 2 configured for the prioritized transmission phase, and perform 1320 the transmission of the data packet based on the selected uplink grant 2 in the prioritized transmission phase 1330.

As another example of the priority rule, the network device 120 may always prioritize an uplink grant configured for the prioritized transmission phase in a collision case, to ensure the data transmission to be successful. In some embodiments, the terminal device 110 may prioritize an uplink grant configured for the prioritized transmission phase over an uplink grant configured for a normal transmission phase, and perform the transmission of the data packet based on the prioritized uplink grant.

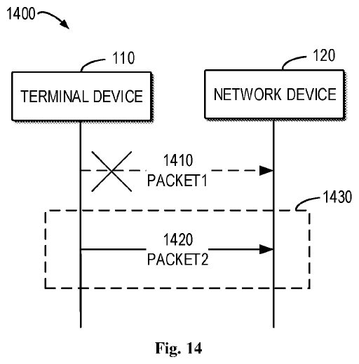

FIG. 14 illustrates a schematic diagram of twelfth interactions 1400 between devices including prioritized transmissions according to some example embodiments of the present disclosure. As shown in FIG. 14, the transmissions of the packet 1 and packet 2 collide with each other. Since the transmission of the packet 2 is prioritized, the terminal device 110 prioritizes the uplink grant for the packet 2 over the uplink grant for the packet 1, and performs 1420 the transmission of the packet 2 based on the prioritized uplink grant in the prioritized transmission phase 1430. In this case, the transmission 1410 of the packet 1 may be abandoned or delayed.

As another example of the priority rule, the network device 120 may configure different priorities to different transmission phases, to ensure the data transmission to be successful. In some embodiments, the terminal device 110 may perform the transmission of the data packet based on a first priority configured for the prioritized transmission phase. The first priority exceeds a second priority configured for a normal transmission phase.

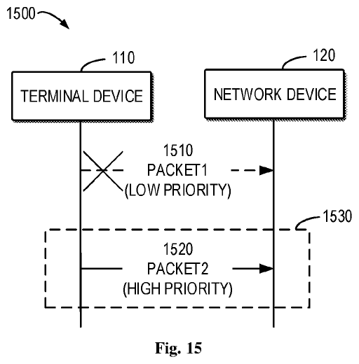

FIG. 15 illustrates a schematic diagram of thirteenth interactions 1500 between devices including prioritized transmissions according to some example embodiments of the present disclosure. As shown in FIG. 15, the transmission of the packet 2 is prioritized. In this case, the terminal device 110 may perform 1520 the transmission of the packet 2 based on a high priority configured for the prioritized transmission phase 1530. In this case, the transmission 1510 of the packet 1 may be abandoned or delayed.

Various priority rules for performing the prioritized transmission of the data packet have been considered, such that the data transmissions can be performed as needed. In this case, the data transmissions may be prioritized to ensure the transmission to be successful, and thus the reliability and performance of RAN can be enhanced.

In some example embodiments, an apparatus capable of performing the method 200 may comprise means for performing the respective steps of the method 200. The means may be implemented in any suitable form. For example, the means may be implemented in a circuitry or software module.

In some example embodiments, the apparatus capable of performing the method 200 comprises: means for, in accordance with a determination that a first condition to enter a prioritized transmission phase is satisfied, prioritizing, based on a first priority rule, data transmissions from a terminal device to a network device and associated with a service; and means for, in accordance with a determination that a second condition to leave the prioritized transmission phase is satisfied, ceasing prioritizing the data transmissions associated with the service.

In some example embodiments, the apparatus capable of performing the method 200 further comprises: means for transmitting capability information of the terminal device to the network device, the capability information indicating that the terminal device supports the prioritized transmission phase; and means for receiving a configuration about the service from the network device, the configuration indicating at least one of: the first condition, the second condition, and the first priority rule.

In some example embodiments, the service is specific to at least one of the following: a logical channel, a data radio bearer and a QoS flow.

In some example embodiments, the apparatus capable of performing the method 200 further comprises: means for, in accordance with failures of a predetermined number of data transmissions associated with the service, determining that the first condition is satisfied.

In some example embodiments, the apparatus capable of performing the method 200 further comprises: means for, in accordance with a failure of a data transmission associated with the service, starting a first timer; means for, in accordance with a success of a data transmission associated with the service, stopping the first timer; and means for, in response to the first timer expiring, determining that the first condition is satisfied.

In some example embodiments, the apparatus capable of performing the method 200 further comprises: means for, in accordance with an indication for entering the prioritized transmission phase from the network device, determining that the first condition is satisfied.

In some example embodiments, the apparatus capable of performing the method 200 further comprises: means for, in accordance with successes of a predetermined number of consecutive data transmissions associated with the service, determining that the second condition is satisfied.

In some example embodiments, the apparatus capable of performing the method 200 further comprises: means for, in accordance with successes of a predetermined number of data transmissions associated with the service within a predetermined time period, determining that the second condition is satisfied.

In some example embodiments, the apparatus capable of performing the method 200 further comprises: means for, in accordance with an indication for leaving the prioritized transmission phase from the network device, determining that the second condition is satisfied.

In some example embodiments, the apparatus capable of performing the method 200 further comprises: means for, in accordance with a failure of a data transmission associated with the service or a determination that the first condition is satisfied, starting a second timer; means for, in accordance with a success of a data transmission associated with the service, stopping the second timer; and means for, in response to the second timer expiring, determining that the second condition is satisfied.

In some example embodiments, the apparatus capable of performing the method 200 further comprises: means for, in accordance with a determination that a third condition to enter a further prioritized transmission phase is satisfied, prioritizing, based on a second priority rule, data transmissions from the terminal device to the network device and associated with the service; and means for, in accordance with a determination that a fourth condition to leave the further prioritized transmission phase is satisfied, ceasing prioritizing data transmissions associated with the service.

In some example embodiments, the apparatus capable of performing the method 200 further comprises: means for, in accordance with a failure of a data transmission associated with the service or determination that the first condition is satisfied, starting a second timer; means for, in accordance with a success of a data transmission associated with the service, stopping the second timer; and means for, in response to the second timer expiring, determining that the third condition is satisfied.

In some example embodiments, the apparatus capable of performing the method 200 further comprises: means for, in accordance with a determination that the third condition is satisfied, starting a third timer; means for, in accordance with successes of a predetermined number of data transmissions associated with the service, stopping the third timer; and means for, in response to the third timer expiring, determining that the fourth condition is satisfied.

In some example embodiments, the means for prioritizing the data transmissions associated with the service comprises: means for prioritizing a data retransmission associated with the service, the data retransmission comprising one of the following: HARQ retransmission, RLC retransmission and PDCP PDU retransmission.

In some example embodiments, the means for prioritizing data transmissions associated with the service comprises: means for prioritizing a new data transmission associated with the service.

In some example embodiments, the means for prioritizing the data transmissions associated with the service comprises: means for marking a data packet associated with the service with a prioritized flag; and means for prioritizing a transmission of the data packet marked with the prioritized flag.

In some example embodiments, the means for prioritizing the transmission of the data packet comprises: means for activating PDCP duplication for the transmission of the data packet.

In some example embodiments, the means for prioritizing the transmission of the data packet comprises: means for selecting, from a plurality of links between the terminal device and the network device, a link with radio quality exceeding a predetermined threshold; and means for performing the transmission of the data packet with the selected link.

In some example embodiments, the means for prioritizing a transmission of the data packet marked with the prioritized flag comprises: means for selecting, from a plurality of uplink grants configured by the network device, an uplink grant with reliability exceeding a predetermined threshold; and means for performing the transmission of the data packet based on the selected uplink grant.

In some example embodiments, the means for prioritizing a transmission of the data packet marked with the prioritized flag comprises: means for selecting, from a plurality of uplink grants configured by the network device, an uplink grant configured for the prioritized transmission phase; and means for performing the transmission of the data packet based on the selected uplink grant.

In some example embodiments, the means for prioritizing a transmission of the data packet marked with the prioritized flag comprises: means for prioritizing an uplink grant configured for the prioritized transmission phase over an uplink grant configured for a normal transmission phase; and means for performing the transmission of the data packet based on the prioritized uplink grant.

In some example embodiments, the means for prioritizing a transmission of the data packet marked with the prioritized flag comprises: means for performing the transmission of the data packet based on a first priority configured for the prioritized transmission phase, the first priority exceeding a second priority configured for a normal transmission phase.

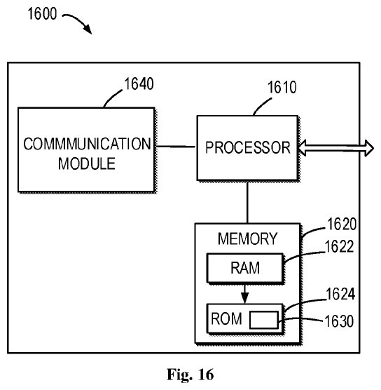

FIG. 16 is a simplified block diagram of a device 1600 that is suitable for implementing embodiments of the present disclosure. For example, the terminal device 110 and/or the network device 120 can be implemented by the device 1600. As shown, the device 1600 includes one or more processors 1610, one or more memories 1620 coupled to the processor 1610, and one or more communication modules 1640 coupled to the processor 1610.

The communication module 1640 is for bidirectional communications. The communication module 1640 has at least one antenna to facilitate communication. The communication interface may represent any interface that is necessary for communication with other network elements.

The processor 1610 may be of any type suitable to the local technical network and may include one or more of the following: general purpose computers, special purpose computers, microprocessors, digital signal processors (DSPs) and processors based on multicore processor architecture, as non-limiting examples. The device 1600 may have multiple processors, such as an application specific integrated circuit chip that is slaved in time to a clock which synchronizes the main processor.

The memory 1620 may include one or more non-volatile memories and one or more volatile memories. Examples of the non-volatile memories include, but are not limited to, a Read Only Memory (ROM) 1624, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 1622 and other volatile memories that will not last in the power-down duration.

A computer program 1630 includes computer executable instructions that are executed by the associated processor 1610. The program 1630 may be stored in the ROM 1624. The processor 1610 may perform any suitable actions and processing by loading the program 1630 into the RAM 1622.

The embodiments of the present disclosure may be implemented by means of the program 1630 so that the device 1600 may perform any process of the disclosure as discussed with reference to FIGS. 2-15. The embodiments of the present disclosure may also be implemented by hardware or by a combination of software and hardware.

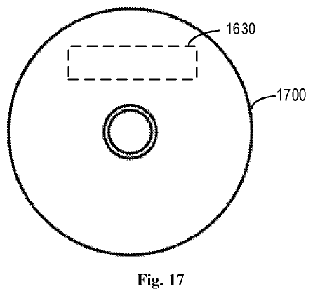

In some example embodiments, the program 1630 may be tangibly contained in a computer readable medium which may be included in the device 1600 (such as in the memory 1620) or other storage devices that are accessible by the device 1600. The device 1600 may load the program 1630 from the computer readable medium to the RAM 1622 for execution. The computer readable medium may include any types of tangible non-volatile storage, such as ROM, EPROM, a flash memory, a hard disk, CD, DVD, and the like. FIG. 17 shows an example of the computer readable medium 1700 in form of CD or DVD. The computer readable medium has the program 1630 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 200 as described above with reference to FIG. 2. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A processor of a terminal device configured to perform operations comprising:
in accordance with a determination that a first condition to enter a prioritized transmission phase is satisfied,
prioritizing, based on a first priority rule, data transmissions associated with a service to a network device; and
in accordance with a determination that a second condition to leave the prioritized transmission phase is satisfied,
ceasing prioritizing the data transmissions associated with the service.

2. The processor of claim 1, further comprising:
transmitting capability information of the terminal device to the network device, the capability information indicating that the terminal device supports the prioritized transmission phase; and
receiving a configuration about the service from the network device, the configuration indicating at least one of: the first condition, the second condition, and the first priority rule.

3. The processor of claim 1, wherein the service is specific to at least one of the following: a logical channel, a data radio bearer and a QoS flow.

4. The processor of claim 1, further comprising:
in accordance with failures of a predetermined number of data transmissions associated with the service, determining that the first condition is satisfied.

5. The processor of claim 1, further comprising:
in accordance with a failure of a data transmission associated with the service, starting a first timer;
in accordance with a success of a data transmission associated with the service, stopping the first timer; and
in response to the first timer expiring, determining that the first condition is satisfied.

6. The processor of claim 1, further comprising:
in accordance with an indication for entering the prioritized transmission phase from the network device, determining that the first condition is satisfied.

7. The processor of claim 1, further comprising:
in accordance with successes of a predetermined number of consecutive data transmissions associated with the service, determining that the second condition is satisfied.

8. The processor of claim 1, further comprising:
in accordance with successes of a predetermined number of data transmissions associated with the service within a predetermined time period, determining that the second condition is satisfied.

9. The processor of claim 1, further comprising:
in accordance with an indication for leaving the prioritized transmission phase from the network device, determining that the second condition is satisfied.

10. The processor of claim 1, further comprising:
in accordance with a failure of a data transmission associated with the service or a determination that the first condition is satisfied, starting a second timer;
in accordance with a success of a data transmission associated with the service, stopping the second timer; and
in response to the second timer expiring, determining that the second condition is satisfied.

11. The processor of claim 1, further comprising:
in accordance with a determination that a third condition to enter a further prioritized transmission phase is satisfied,
prioritizing, based on a second priority rule, data transmissions from the terminal device to the network device and associated with the service; and
in accordance with a determination that a fourth condition to leave the further prioritized transmission phase is satisfied,
ceasing prioritizing data transmissions associated with the service.

12. The processor of claim 11, further comprising:
in accordance with a failure of a data transmission associated with the service or determination that the first condition is satisfied, starting a second timer;
in accordance with a success of a data transmission associated with the service, stopping the second timer; and
in response to the second timer expiring, determining that the third condition is satisfied.

13. The processor of claim 11, further comprising:
in accordance with a determination that the third condition is satisfied, starting a third timer;
in accordance with successes of a predetermined number of data transmissions associated with the service, stopping the third timer; and
in response to the third timer expiring, determining that the fourth condition is satisfied.

14. The processor of claim 1, wherein prioritizing the data transmissions associated with the service comprises:
prioritizing a data retransmission associated with the service, the data retransmission comprising one of the following: HARQ retransmission, RLC retransmission and PDCP PDU retransmission.

15. The processor of claim 1, wherein prioritizing data transmissions associated with the service comprises:
prioritizing a new data transmission associated with the service.

16. The processor of claim 1, wherein prioritizing the data transmissions associated with the service comprises:
marking a data packet associated with the service with a prioritized flag; and
prioritizing a transmission of the data packet marked with the prioritized flag.

17. The processor of claim 16, wherein prioritizing the transmission of the data packet comprises:
activating PDCP duplication for the transmission of the data packet.

18. The method of claim 16, wherein prioritizing the transmission of the data packet comprises:
selecting, from a plurality of links between the terminal device and the network device, a link with radio quality exceeding a predetermined threshold; and
performing the transmission of the data packet with the selected link.

19. The processor of claim 16, wherein prioritizing a transmission of the data packet marked with the prioritized flag comprises:
selecting, from a plurality of uplink grants configured by the network device, an uplink grant with reliability exceeding a predetermined threshold; and
performing the transmission of the data packet based on the selected uplink grant.

20. The processor of claim 16, wherein prioritizing a transmission of the data packet marked with the prioritized flag comprises:
selecting, from a plurality of uplink grants configured by the network device, an uplink grant configured for the prioritized transmission phase; and
performing the transmission of the data packet based on the selected uplink grant.

21-24. (canceled)
